(19) United States
(12) Patent Application Publication
(10) Pub. No.: US 2017/0193429 A1
(43) Pub. Date: Jul. 6, 2017

(54) APPARATUS AND METHOD FOR MONITORING A VIRTUAL PRODUCT LIBRARY

(71) Applicant: Checkpoint Systems, Inc., Thorofare, NJ (US)

(72) Inventor: Daniel James Olson, Voorhees, NJ (US)

(21) Appl. No.: 14/983,726

(22) Filed: Dec. 30, 2015

(51) Int. Cl. G06Q 10/08; G06Q 30/06

(52) U.S. Cl. CPC G06Q 10/087; G06Q 30/0623

(57) ABSTRACT

A personal inventory manager may include processing circuitry. The processing circuitry may be configured to monitor a virtual product library of a user, where the virtual product library is generated based on product information corresponding to at least one product and profile information corresponding to information about the user. The processing circuitry may be further configured to provide recommended actions to the user based on the product information and the profile information in the virtual product library.

### TECHNICAL FIELD

Example embodiments generally relate to monitoring a virtual product library, and more particularly to recommending an action to a user based on monitoring the virtual product library.

### BACKGROUND

A person may own numerous products such as shoes, shirts, dresses, pants, jewelry, tools, DVDs, CDs, electronics, or the like. Even further, a person may see numerous products that he or she wishes to buy. When shopping, a person doesn't always remember their size in a particular style of clothing or remember what products they own. In some cases, a person may want to know if an item is something they do not already have when shopping. However, it may be difficult for a person to remember what he or she owns or wants to buy, much less remember when the last time a certain product was worn or used, how often the product has been worn or used, or what store the product was bought or seen.

### BRIEF SUMMARY OF SOME EXAMPLES

Some example embodiments may provide a personal inventory manager that includes processing circuitry. The processing circuitry may be configured to monitor a virtual product library of a user, where the virtual product library is generated based on product information corresponding to at least one product and profile information corresponding to information about the user. The processing circuitry may be further configured to provide recommended actions to the user based on the product information and the profile information in the virtual product library.

In another example embodiment, a method is provided which includes monitoring a virtual product library of a user, where the virtual product library is generated based on product information corresponding to at least one product and profile information corresponding to information about the user, and providing recommended actions to the user based on the product information and the profile information in the virtual product library.

### BRIEF DESCRIPTION OF THE SEVERAL VIEWS OF THE DRAWING(S)

Having thus described some example embodiments in general terms, reference will now be made to the accompanying drawings, which are not necessarily drawn to scale, and wherein:

FIG. 1 illustrates a block diagram of a system in which a personal inventory manager may be employed in accordance with an example embodiment;

FIG. 2 illustrates a block diagram of a personal inventory manager in accordance with an example embodiment;

FIGS. 3-4 illustrate user interface renderings in accordance with an example embodiment;

FIG. 5 illustrates a block diagram of a personal inventory manager in accordance with a further example embodiment;

FIG. 6 illustrates a diagram of a personal inventory manager in accordance with a further example embodiment; and

FIG. 7 illustrates a block diagram of a method in accordance with a further example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. As used herein, operable coupling should be understood to relate to direct or indirect connection that, in either case, enables functional interconnection of components that are operably coupled to each other.

As used herein, the terms “component,” “module,” and the like are intended to include a computer-related entity, such as but not limited to hardware, firmware, or a combination of hardware and software. For example, a component or module may be, but is not limited to being, a process running on a processor, a processor, an object, an executable, a thread of execution, or a computer. By way of example, both an application running on a computing device or the computing device can be a component or module. One or more components or modules can reside within a process or thread of execution and a component/module may be localized on one computer or distributed between two or more computers. In addition, these components can execute from various computer readable media having various data structures stored thereon. The components may communicate by way of local or remote processes such as in accordance with a signal having one or more data packets, such as data from one component/module interacting with another component/module in a local system, distributed system, or across a network such as the Internet with other systems by way of the signal. Each respective component/module may perform one or more functions that will be described in greater detail herein. However, it should be appreciated that although this example is described in terms of separate modules corresponding to various functions performed, some examples may not necessarily utilize modular architectures for employment of the respective different functions. Thus, for example, code may be shared between different modules, or the processing circuitry itself may be configured to perform all of the functions described as being associated with the components/modules described herein. Furthermore, in the context of this disclosure, the term “module” should not be understood as a nonce word to identify any generic means for performing functionalities of the respective modules. Instead, the term “module” should be understood to be a modular component that is specifically configured in, or can be operably coupled to, the processing circuitry to modify the behavior or capability of the processing circuitry based on the hardware or software that is added to or otherwise operably coupled to the processing circuitry to configure the processing circuitry accordingly.

In order for a person to keep track of the products he or she owns or wishes to buy, the person may store these products in a virtual product library that may be accessed from a mobile device, computing device, or the like. When the person stores these products in the virtual product library, the products and any further actions the person takes regarding the products, such as selecting the product was worn/used or selecting an option to be informed of sales corresponding to the product or similar products, may be monitored. Based on the monitoring of the products in the virtual product library and any actions taken regarding the products, a personal inventory manager may be configured to recommend actions to the person based on the information in the virtual product library. By recommending actions to the person, the person can efficiently and more effectively manage his or her existing or desired personal inventory.

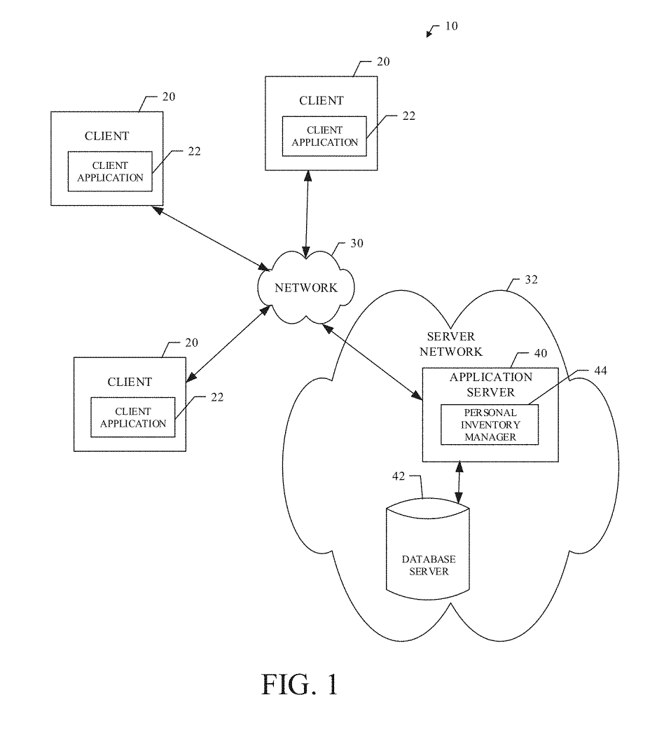

FIG. 1 illustrates an example system in which a personal inventory manager 44 may be employed. As shown in FIG. 1, a system 10 according to an example embodiment may include one or more client devices (e.g., clients 20). Notably, although FIG.1 illustrates three clients 20, it should be appreciated that the number of clients 20 is in no way limiting to further example embodiments. Furthermore, some example embodiments may be practiced on a single client without any connection to the system 10.

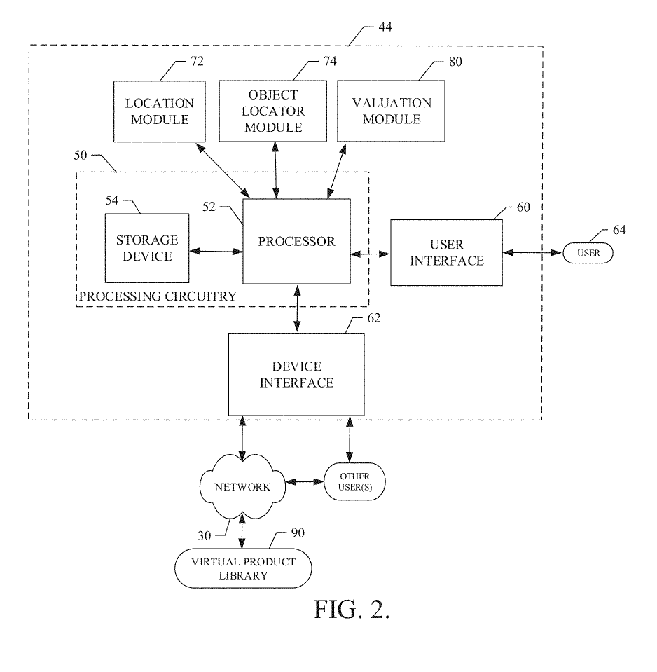

The example embodiment described herein relates to a client 20 comprising a mobile computing device. However, it should be appreciated that further example embodiments may apply to any asset including, for example, any programmable device that is configured to provide a recommended action to a user (e.g., user of FIG. 2) based on information corresponding to the user and at least one product in a virtual product library, as described herein.

Each one of the clients 20 may include or otherwise be embodied as computing device (e.g., a computer, a network access terminal, a personal digital assistant (PDA), cellular phone, smart phone, or the like) capable of communication with a network 30. As such, for example, each of the clients 20 may include (or otherwise have access to) memory for storing instructions or applications for the performance of various functions and a corresponding processor for executing stored instructions or applications. Each of the clients 20 may also include software or corresponding hardware for enabling the performance of the respective functions of the clients 20 as described below. In an example embodiment, one or more of the clients 20 may include a client application 22 configured to operate in accordance with an example embodiment. In this regard, for example, the client application 22 may include software for enabling a respective one of the clients 20 to communicate with the network 30 for requesting or receiving information or services via the network 30. Moreover, in some embodiments, the information or services that are requested via the network may be provided in a software as a service (SAS) environment. The information or services receivable at the client applications 22 may include deliverable components (e.g., downloadable software to configure the clients 20, or information for consumption/processing at the clients 20). As such, for example, the client application 22 may include corresponding executable instructions for configuring the client 20 to provide corresponding functionalities for monitoring a virtual product library and providing a recommended action to the user 64, as described herein.

The network 30 may be a data network, such as a local area network (LAN), a metropolitan area network (MAN), a wide area network (WAN) (e.g., the Internet), or the like, which may couple the clients 20 to devices such as processing elements (e.g., personal computers, server computers, or the like) or databases. Communication between the network 30, the clients 20, and the devices or databases (e.g., servers) to which the clients 20 are coupled may be accomplished by either wired or wireless communication mechanisms and corresponding communication protocols.

In an example embodiment, devices to which the clients 20 may be coupled via the network 30 may include one or more application servers (e.g., application server 40), or a database server 42, which together may form respective elements of a server network 32. Although the application server 40 and the database server 42 are each referred to as “servers,” this does not necessarily imply that the application server 40 and the database server 42 are on separate servers or devices. As such, for example, a single server or device may include both the application server 40 and the database server 42, and the database server 42 could merely be represented by a database or group of databases physically located on the same server or device as the application server 40. The application server 40 and the database server 42 may each include hardware or software for configuring the application server 40 and the database server 42, respectively, to perform various functions. As such, for example, the application server 40 may include processing logic and memory enabling the application server 40 to access or execute stored computer readable instructions for performing various functions. In an example embodiment, one function that may be provided by the application server 40 may be the provision of access to information or services related to operation of the clients 20. For example, the application server 40 may be configured to provide for storage of information descriptive of motion or location. In some cases, these contents may be stored in the database server 42. Alternatively or additionally, the application server 40 may be configured to provide analytical tools for use by the clients 20 in accordance with example embodiments.

In some embodiments, for example, the application server 40 may therefore include an instance of the personal inventory manager 44 comprising stored instructions for handling activities associated with example embodiments described herein. As such, in some embodiments, the clients 20 may access the personal inventory manager 44 online and utilize the services provided thereby. However, it should be appreciated that in other embodiments, the personal inventory manager 44 may be initiated from an integrated memory of the client 20. In some example embodiments, the personal inventory manager 44 may be provided from the application server 40 (e.g., via download over the network 30) to one or more of the clients 20 to enable recipient clients to instantiate an instance of the personal inventory manager 44. As yet another example, the personal inventory manager 44 may be instantiated at one or more of the clients 20 responsive to downloading instructions from a removable or transferable memory device carrying instructions for instantiating the personal inventory manager 44 at the corresponding one or more of the clients 20. In such an example, the network 30 may, for example, be a peer-to-peer (P2P) network where one of the clients 20 includes an instance of the personal inventory manager 44 to enable the corresponding one of the clients 20 to act as a server to other clients 20. In a further example embodiment, personal inventory manager 44 may be distributed amongst one or more clients 20 or the application server 40.

In an example embodiment, the application server 40 may include or have access to memory (e.g., internal memory or the database server 42) for storing instructions or applications for the performance of various functions and a corresponding processor for executing stored instructions or applications. For example, the memory may store an instance of personal inventory manager 44 configured to operate in accordance with example embodiments described herein. In this regard, for example, the personal inventory manager 44 may include software for enabling the application server 40 to communicate with the network 30 or the clients 20 for the provision or receipt of information associated with performing activities as described herein. Moreover, in some embodiments, the application server 40 may include or otherwise be in communication with an access terminal (e.g., a computer including a user interface) via which analysts may interact with, configure, or otherwise use to maintain the system 10.

FIG. 2 illustrates a block diagram of a personal inventory manager 44 in accordance with an example embodiment. The personal inventory manager 44 may be employed, for example, on a client (e.g., any of the clients 20 of FIG. 1) or a variety of other devices (such as, for example, a network device, server, proxy, or the like (e.g., the application server 40 of FIG. 1)). Additionally or alternatively, embodiments may be employed on a combination of devices. Accordingly, some example embodiments may be embodied wholly at a single device (e.g., the application server 40 or one or more clients 20) or by devices in a client/server relationship (e.g., the application server 40 and one or more clients 20). Furthermore, it should be noted that the devices or elements described below may not be mandatory and thus some may be omitted in certain embodiments.

As shown in FIG. 2, a personal inventory manager 44 is provided that is configured to monitor the virtual product library 90 of a user 64 (where the user 64 corresponds to or uses one of the clients 20) and provide a recommended action to the user 64 based on information corresponding to the user 64 and at least one product in the virtual product library 90. In an example embodiment, the personal inventory manager 44 may include or otherwise be in communication with processing circuitry 50 that is configured to perform data processing, application execution, and other processing and management services. In one example embodiment, the processing circuitry 50 may include a storage device 54 and a processor 52 that may be in communication with or otherwise control a user interface 60 and a device interface 62. As such, the processing circuitry 50 may be embodied as a circuit chip (e.g., an integrated circuit chip) configured (e.g., with hardware, software, or a combination of hardware and software) to perform operations described herein. However, in further example embodiments, the processing circuitry 50 may be embodied as a portion of a server, computer, laptop, cell phone, or workstation. In situations where the processing circuitry 50 is embodied at a server or at a remotely located computing device, the user interface 60 may be disposed at another device (e.g., at a computer terminal or client device such as one of the clients 20) that may be in communication with the processing circuitry 50 via the device interface 62 or a network (e.g., network 30).

The user interface 60 may be in communication with the processing circuitry 50 to receive an indication of a user input at the user interface 60 or to provide an audible, visual, mechanical or other output to the user 64. As such, the user interface 60 may include, for example, a keyboard, a mouse, a joystick, a display, a touch screen, a microphone, a speaker, a cell phone, or other input/output mechanisms. In embodiments where the personal inventory manager 44 is embodied at a server or other network entity, the user interface 60 may be limited. Alternatively, as indicated above, the user interface 60 may be remotely located.

The device interface 62 may include one or more interface mechanisms for enabling communication with other devices or networks. In some cases, the device interface 62 may be any means such as a device or circuitry embodied in either hardware, software, or a combination of hardware and software that is configured to receive or transmit data from/to a network or any other device or module in communication with the processing circuitry 50. In this regard, the device interface 62 may include, for example, an antenna (or multiple antennas) and supporting hardware, software for enabling communications with a wireless communication network, or a communication modem or other hardware/software for supporting communication via cable, digital subscriber line (DSL), universal serial bus (USB), Ethernet, or other methods. In situations where the device interface 62 communicates with a network, the network may be any of various examples of wireless or wired communication networks such as, for example, data networks like a Local Area Network (LAN), a Metropolitan Area Network (MAN), or a Wide Area Network (WAN), such as the Internet.

In an example embodiment, the storage device 54 may include one or more non-transitory storage or memory devices such as, for example, volatile or non-volatile memory that may be either fixed or removable. The storage device 54 may be configured to store information, data, applications, instructions or the like for enabling the personal inventory manager 44 to carry out various functions in accordance with example embodiments. For example, the storage device 54 could be configured to buffer input data for processing by the processor 52. Additionally or alternatively, the storage device 54 could be configured to store instructions for execution by the processor 52. In a further example embodiment, the storage device 54 may include one of a plurality of databases (e.g., database server 42) that may store a variety of files, contents, or data sets. Among the contents of the storage device 54, applications (e.g., client application 22 or service application 42) may be stored for execution by the processor 52 in order to carry out the functionality associated with each respective application.

The processor 52 may be embodied in a number of different ways. For example, the processor 52 may be embodied as various processing means such as a microprocessor or other processing element, a coprocessor, a controller or various other computing or processing devices including integrated circuits such as, for example, an ASIC (application specific integrated circuit), an FPGA (field programmable gate array), a hardware accelerator, or the like. In an example embodiment, the processor 52 may be configured to execute instructions stored in the storage device 54 or otherwise accessible to the processor 52. As such, whether configured by hardware or software methods, or by a combination thereof, the processor 52 may represent an entity (e.g., physically embodied in circuitry) capable of performing operations according to example embodiments. Thus, for example, when the processor 52 is embodied as an ASIC, FPGA, or the like, the processor 52 may be specifically configured hardware for conducting the operations described herein. Alternatively, when the processor 52 is embodied as an executor of software instructions, the instructions may specifically configure the processor 52 to perform the operations described herein.

In an example embodiment, the processor 52 (or the processing circuitry 50) may be embodied as, include, or otherwise control the personal inventory manager 44, which may be any means, such as, a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the personal inventory manager 44 as described below.

The personal inventory manager 44 may monitor the virtual product library 90 of the user 64, and recommend suggested actions to the user 64 based on content in the user's virtual product library 90 via the client 20, server network 32, network 30, or a combination thereof. In some cases, the virtual product library 90 may be generated based on information corresponding to the user 64 (e.g., profile information) and at least one product. For example, when the user 64 initially creates a virtual product library 90, the user 64 may input or create a profile that includes profile information about him or her. This information may include, but is not limited to, the user's name, body measurements (e.g., dress size, shoe size, etc.), product preferences, birth date, age, and/or favorite retail stores. In some cases, the user 64 may input this information manually into the virtual product library 90. Once the user 64 has inputted or created his or her profile, the user 64 can then add information about the product or products into the virtual product library 90. The product may include a 1) product the user 64 has already purchased (e.g., an article of clothing the user has in his or her closet); or 2) product the user 64 has not purchased (e.g., a wish list item or an article of clothing the user likes or desires to purchase). The information corresponding to the product (e.g., product information) may include, but is not limited to, the product's description (e.g., associated season, features, material, associated activity or the like), model, product identification number (UPC or SKU), store location, price, size, color, age, wear, brand, or designer. The user 64 may input the product information manually, by scanning a label of the product, by taking a picture of the product, or some combination of the following. Scanning the label of the product may involve scanning a bar code on the label using a bar code scanner to obtain product information, scanning an RFID tag on the label to obtain product information, or both. As shown in FIG. 2, the virtual product library 90 may be embodied separately from the personal inventory manager 44; however, in further example embodiments, the virtual product library may be embodied at the personal inventory manager 44.

Once the virtual product library 90 has information corresponding to the user or information corresponding to at least one product, the personal inventory manager 44 may be configured to monitor the virtual product library 90 of the user 64 relative to internal or external trigger events. For example, internal trigger events may include the products stored in the virtual product library 90, how many times the product has been worn, a pre-determined period of non-use, or the like. External trigger events may be based on searching website of various retailers for applicable product sales or promotions, the location of the user 64, or the like. The personal inventory manager 44 may monitor the virtual product library 90 on a real time, hourly basis, daily basis, a specific interval set by the user, or any pre-determined interval, or responsive to occurrence of internal or external trigger events. Based on monitoring the virtual product library 90 of the user 64, the personal inventory manager 44 may provide recommended actions to the user 64 based on the information corresponding to the user or at least one product. In some cases, the recommended action may be provided to the user 64 on the user interface 60. For example, the user 64 may input into the user's virtual product library 90 that the user 64 owns a pair of white tennis shoes. Even further, the user 64 may access the virtual product library 90 after each time they wear the white tennis shoes to select or indicate the user 64 has worn the shoes. After a certain number of wears of the white tennis shoes, the personal inventory manager 44 may be configured to recommend to the user that the shoes should be disposed of or be replaced. In further example embodiments, relative to an external trigger event, such as an internet search for similar local available products meeting the description of the white tennis shoes or a sale or promotion on a similar or matching product, the personal inventory manager 44 may be configured to recommend to the user that the white tennis shoes are locally available or discounted at a retailer. In some cases, if the user 64 is in a retail store, the personal inventory manager 44 may be configured to alert the user 64 to a similar product (e.g., product having similar characteristics to the white tennis shoes) that is within the retail store and the estimated location in the retail store in which the similar product is located.

The personal inventory manager 44 may be configured to provide numerous recommended actions based on the information stored in the virtual product library 90. In one example embodiment, such as described above, the personal inventory manager 44 may recommend disposing of a product based on non-use, a pre-determined number of wears, or the age of the product. For example, if a pre-determined time (e.g., one year) goes by without the user inputting in the virtual product library 90 that the user 64 has worn a certain product, the personal inventory manager 44 may recommend disposing of the product. In a further example embodiment, such as when the product has been recently added, the recommended action of the personal inventory manager 44 may include alerting the user 64 that he or she has previously entered a similar product in the virtual product library 90. In even further example embodiments, the personal inventory manager 44 may recommend disposing of a product based on excessive use. In some cases, when the personal inventory manager 44 recommends disposing of a product, or if the user 64 decides to dispose of a product on their own, the personal inventory manager 44 may be configured to provide an estimated value of the product if the user would like to sell the product or give it to charity.

As discussed above, if the personal inventory manager 44 recommends disposing of the product or if the user 64 decides to dispose of the product, the personal inventory manager 44 may be further configured to estimate or determine the value of the product. To determine an estimated value of the product, the processing circuitry 50 may utilize a valuation module 80 to facilitate a valuation query of similar product or products that are being sold or have been sold. In an example embodiment, the valuation module 80 may be configured to receive identifying information of the product and cause, by the processing circuitry 50, a valuation query to be transmitted based on the product identity. In one example embodiment, during the valuation query, various online platforms (such as auction or local classifieds websites) may be searched to find similar products that have been sold or are currently for sale during a pre-determined time range (e.g., last 6 months). Based on the similar items found, the valuation module 80 may be configured to determine an estimated value of the product. In further example embodiments, the valuation module 80, during the valuation query, may reference stored data tables that include age, product description, and value of various products to determine an estimated value of the product.

In some embodiments, the valuation module 80 may further include one or more components or modules that may be individually configured to perform one or more of the individual tasks or functions generally attributable to the valuation module 80. However, the valuation module 80 need not necessarily be modular. In cases where the valuation module 80 employs modules, the modules may, for example, be configured for causing a valuation query based on the product that may be disposed. In some embodiments, the valuation module 80 or any modules comprising the valuation module 80 may be any means such as a device or circuitry operating in accordance with software or otherwise embodied in hardware or a combination of hardware and software (e.g., processor 52 operating under software control, the processor 52 embodied as an ASIC or FPGA specifically configured to perform the operations described herein, or a combination thereof) thereby configuring the device or circuitry to perform the corresponding functions of the valuation module 80 or any modules thereof, as described herein.

In some cases, where the product is given to charity rather than sold, the estimated value of the product may be used for tax purposes. Even further, the personal inventory manager 44 may be configured to store what product or products have been disposed of, how the product or products were disposed (e.g., selling, charity, or trash), and what the estimated value of the product was at the time it was disposed of.

In a further example embodiment, if personal inventory manager 44 recommends disposing of the product or the user indicates that he has disposed of the product in the virtual product library 90, the personal inventory manager 44 may be configured to recommend to the user 64 to replenish or replace the product. In some cases, the processing circuitry 50 may utilize an object locator module 74 to facilitate an inventory query of participating retailers based on the product that needs replenished or replaced. In some cases, the object locator module 74 may be embodied in a physical and functional form in a similar manner to that which has been described above. For example, the object locator module 74 may include processing circuitry or be embodied in the processor 52.

The object locator module 74 may be configured to receive the identifying information of the product that may need to be replenished, receive a user location indication, and cause, by the processing circuitry 50, an inventory query to be transmitted to participating retailers based on the product identity and the user location indication. By causing an inventory query to be transmitted to participating retailers, in addition to recommending the user 64 replenish the product, the personal inventory manager 44, in some cases, may be configured to also recommend retailers in a pre-defined area that may have similar products in stock, the price of the product, or promotions associated with the product.

In a further example embodiment, to facilitate the inventory query, the personal inventory manager 44 may include a location module 72. The location module 72 may be configured to determine a location of the personal inventory manager 44 (or the client 20 if the personal inventory manager 44 is remotely embodied). In some cases, the location module 72 may be a global positioning sensor, a visual navigation device, an inertial navigation system, or the like. The processing circuitry 50 may receive a user location indication from the user interface 60 or a location module 72. The location module 72 may provide a current location based on one or more positioning systems, such as global positioning. The user interface 60 may receive user input such as an address, a map point selection, or the like, indicating the user location. For example, if the inventory query is being performed, the processing circuitry 50 may cause the device interface 62 to transmit the query based on the product identity and the user location. The query may include a radius associated with the user location, such as ¼ mile, 5 miles, 40 miles, or any other radius. The radius may be selected by the user via the user interface 60. In some embodiments, the radius may be automatically determined by the processing circuitry 50 based on mode of travel, environment, retailer density, or the like. Additionally or alternatively, the radius may be automatically determined and adjusted by the user.

The inventory of participating retailers may be stored in one or more databases, such as database server 42. The processing circuitry 50 may query the databases which include product inventories for retailers located within the radius of the user location. The processing circuitry 50 may receive at least one inventory result, from the one or more inventory databases of the participating retailers, indicating that the retailer or merchant associated with the inventory result has indicated at least one of the product or a similar product in inventory. The inventory result may include the location information of the retailer or merchant, price of the product, or the like.

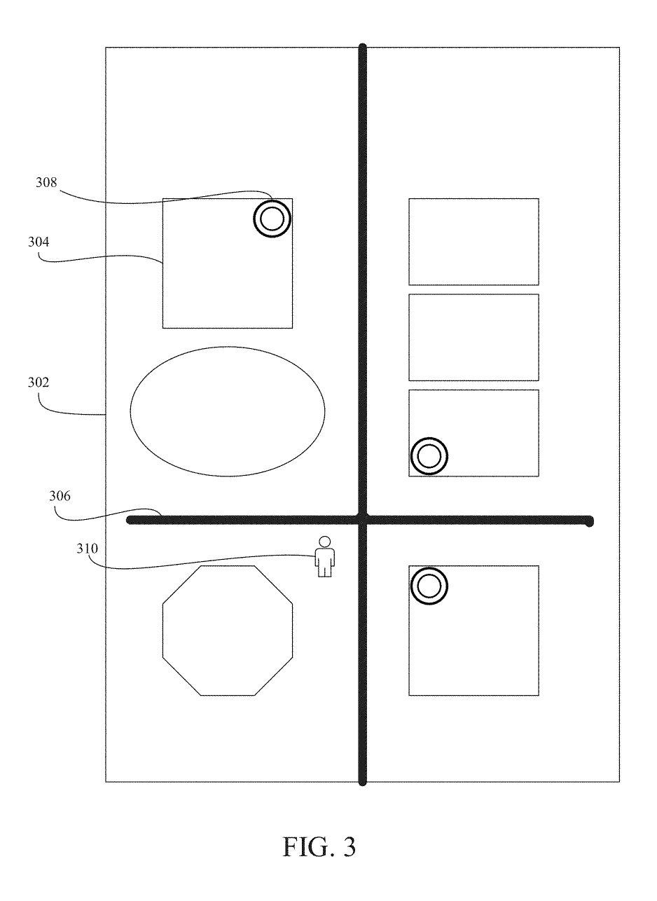

As shown in FIG. 3, the processing circuitry 50 may cause the location of the retailer having a matching or similar product to be displayed on the user interface 60. Additionally or alternatively, the processing circuitry 50 may render the location of one or more retailers having the matching or similar product on a map rendering, such as map rendering 302. The map rendering 302 may include landmarks 306, such as streets, structures, parks, or the like. The retailer locations 308 may be depicted at or near the location information provided. In some embodiments, the map rendering 302 may include building outlines 304. The retailer locations 308 may be rendered, in some instances, at an approximate position of the retailer, merchant, or the product within the building. In some instances, such as a large retailer or mall, the map rendering 302 may be the layout of the inside of a building and identify the approximate position of the product within the building. The map rendering 302 may additionally include the user location 310.

The retailer location 308 may be selectable in one or more embodiment, which may cause the processing circuitry 50 to render retail information. The retail information may be requested and received by the processing circuitry 50 from a database, such as the inventory database, in response to the selection of the retailer location, with the reception of the inventory results, or the like.

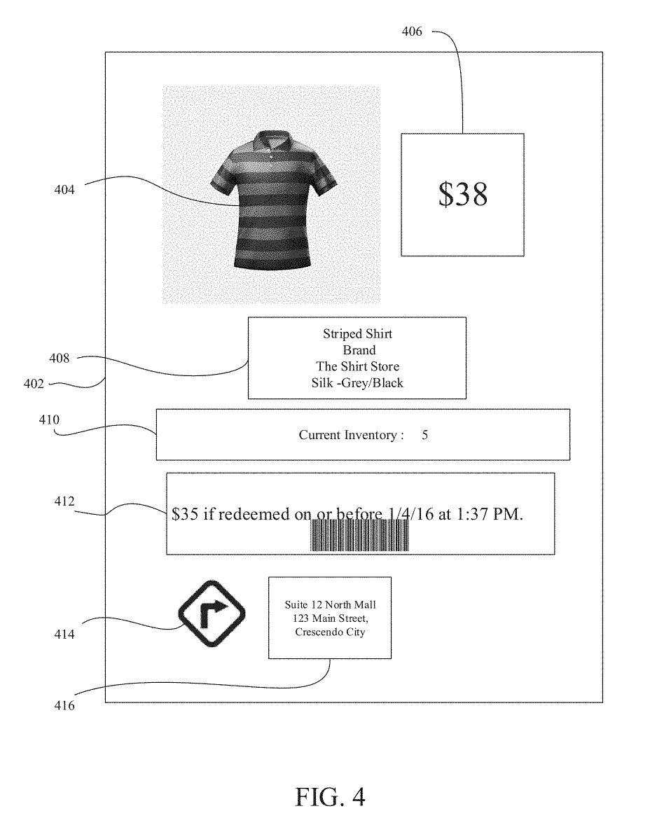

As shown in FIG. 4, the retail information 402 may be displayed on a user interface 60. The retail information 402 may include a picture, video, or other rendering of the product 404 matching the product which is being replenished or replaced (a shirt in the depicted example). The retail information 402 may also have a product description 408, which may include the product name, the brand or manufacturer, the retailer name, material, color, or the like. The retail information may include a price of the product 406. The retail information 402 may include the quantity of inventory of the product at the retail location. Additionally or alternatively, the retail information 402 may include directions or a turn by turn navigation link 414, configured to provide directions based on the retailer address 416 or location 308 and the user location 410.

As further shown in FIG. 4, a redemption coupon 412 may also be provided to the user 64. The redemption coupon 412 may be generated based on the retail information 402. The redemption coupon 412 may be displayed in the same or different viewing area as the retail information 402 on the user interface 60. The redemption coupon 412 may be a reduced price, such as a percentage, set price, value off retail price, or the like. For example, the redemption coupon 412 may provide for $35.00 at redemption instead of the $38.00 retail price. In some example embodiments, the redemption coupon 412 may have an expiration date. The expiration date may be based on the current time of the inventory query, distance between the retailer location 308 and the user location 310, or the like. For example, the expiration date may be shown as hours, days, or the like. In some example embodiments, the redemption coupon 412 may include a unique identifier such as a bar code, quick response (QR) code, or the like, which may be used for validation of the offer. In an example embodiment, the retail location 408 associated with a redemption coupon 412 may be rendered to differentiate the indicator, such as by a different shape, size or color.

In an even further example embodiment, the personal inventory manager 44 may be configured to recommend and send, in a similar manner and embodiment as described above, coupons or discounts based on products in the virtual product library 90, such as those products the user has on a wish list within the virtual product library 90 or those products the user has indicated they wish or desire to purchase (e.g., those products on the user's wish list).

In a further example embodiment, the personal inventory manager 44 may have a mechanism for developing intelligence about the user 64. For example, based on actions taken in the virtual product library 90 of the user 64 or actions such as travel patterns, use of the virtual product library 90, purchase patterns, or the like, the personal inventory manager 44 may be able to tailor recommended actions such that the recommend actions are specific to that user 64.

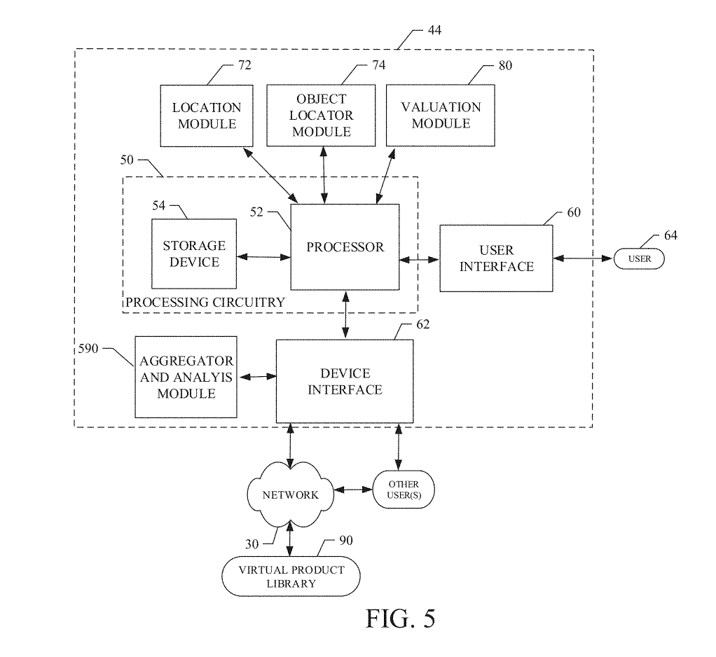

FIG. 5 illustrates a block diagram of a personal inventory manager 44 in accordance with a further example embodiment. As further shown in FIG. 5, the personal inventory manager 44 may include an aggregator and analysis module 590. In some embodiments, an aggregator and analysis module 590 may be embodied in physical and functional form in a similar manner to that which has been described above. For example, the aggregator and analysis module 590 may include processing circuitry or be embodied in the processor 52. The aggregator and analysis module 590 may be utilized by the personal inventory manager 44 to recommend adding additional products to the virtual product library 90 based on what is currently stored in the library. Even further, the aggregator and analysis module 590 may control subscription service related activities. For example, retailers may pay a subscription fee to participate and be shown in the inventory query. For example, retailers may pay so that their inventory may be included and searched when the personal inventory manager 44 performs an inventory query. Even further, the retailers subscribe to receive reports on what the user 64 or multiple users 64 add to their product library or the like. The aggregator and analysis module 590 may be configured to decide what type of trend analysis or data should be sent to participating retailers. In some cases, retailers may subscribe so that the personal inventory manager 44 may send target advertisements of the retailer to the user 64 based on the contents of the user's virtual product library 90.

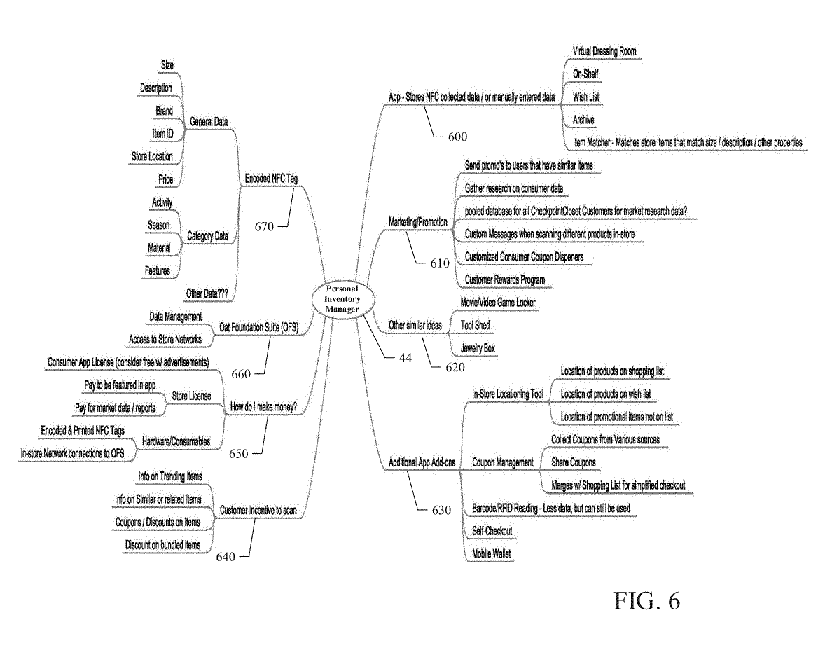

FIG. 6 illustrates a diagram of a personal inventory manager 44 in accordance with a further example embodiment. As shown in FIG. 6, the personal inventory manager 44 may be utilized in a variety of different hierarchical contexts 600, 610, 620, 630, 640, 650, 660, and 670. Each hierarchical context 600, 610, 620, 630, 640, 650, 660, and 670 may have corresponding associated information. For example, in hierarchical context 630, the processing circuitry 50 of the personal inventory manager 44 may work in conjunction with or may be used to facilitate the additional functions of 1) in-store locationing (e.g., locating products stored in user's virtual product library 90 or locating store's promotional items and sending an alert to the user while user is in the store regardless of whether the promotional items may or may not be stored in virtual product library 90); 2) coupon management (e.g., collecting coupons received from participating retailers, sharing coupons with other users, or merging coupons with self-checkout/shopping list for simplified checkout); 3) barcode/RFID reading; 4) self-checkout; or 5) mobile wallet.

From a technical perspective, the personal inventory manager 44 described above may be used to support some or all of the operations described above. As such, the platforms described in FIGS. 1-6 may be used to facilitate the implementation of several computer program or network communication based interactions.

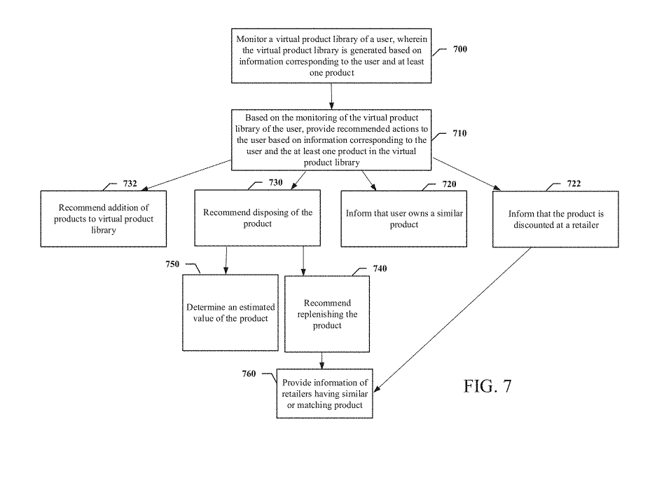

As an example, FIG. 7 is a flowchart of an example method according to example embodiments of the invention. It will be understood that each block of the flowchart, and combinations of blocks in the flowchart, may be implemented by various means, such as hardware, firmware, processor, circuitry or other device associated with execution of software including one or more computer program instructions. For example, one or more of the procedures described above may be embodied by computer program instructions. In this regard, the computer program instructions which embody the procedures described above may be stored by a memory device of a user terminal and executed by a processor in the user terminal. As will be appreciated, any such computer program instructions may be loaded onto a computer or other programmable apparatus (e.g., hardware) to produce a machine, such that the instructions which execute on the computer or other programmable apparatus create means for implementing the functions specified in the flowchart block(s). These computer program instructions may also be stored in a computer-readable memory that may direct a computer or other programmable apparatus to function in a particular manner, such that the instructions stored in the computer-readable memory produce an article of manufacture which implements the functions specified in the flowchart block(s). The computer program instructions may also be loaded onto a computer or other programmable apparatus to cause a series of operations to be performed on the computer or other programmable apparatus to produce a computer-implemented process such that the instructions which execute on the computer or other programmable apparatus implement the functions specified in the flowchart block(s).

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In this regard, FIG. 7 is a method according to an example embodiment. The method may be employed by a personal inventory manager 44. The method may include, monitoring a virtual product library of the user, wherein the virtual product library is generated based on information corresponding to the user and at least one product, at operation 700. At operation 710, the method may further include, based on the monitoring of the virtual product library of the user, providing recommended actions to the user based on information corresponding to the user and the at least one product in the virtual product library. The recommended actions may include recommending disposing of the product, at operation 730. Alternatively or additionally, at operation 720, the recommended action may include informing that a recently added product to the virtual product library is similar to a product previously entered in the virtual product library. Alternatively or additionally, at operation 722, the recommended action may include informing that a product in the virtual product library is currently discounted at a retailer. Alternatively or additionally, at operation 732, the recommended action may include recommending to the user the addition of products to the virtual product library.

In cases where the personal inventory manager recommends disposing of the product, at operation 750, the estimated value of the product may be determined. Alternatively or additionally, at operation 740, in addition to recommending disposing of the product, replenishing the product may be recommended. When it is recommended to replenish the product or if the user is informed that the product is discounted at a retailer, information of retailers having similar or matching products may be provided, at operation 760.

Example embodiments therefore represent a personal inventory manager that may monitor information corresponding to the user and at least one product in the virtual product library and any actions taken regarding the at least one product. Based on this monitoring, the personal inventory manager may be configured to recommend actions to the user based on the information and actions taken in the virtual product library.

In some embodiments, additional optional structures or features may be included or the structures/features described above may be modified or augmented. Each of the additional features, structures, modifications, or augmentations may be practiced in combination with the structures/features above or in combination with each other. Thus, some, all or none of the additional features, structures, modifications or augmentations may be utilized in some embodiments. Some example additional optional features, structures, modifications, or augmentations are described below, and may include, for example, that the processing circuitry may be further configured to receive the profile information via manual user input. In a further example embodiment, the processing circuitry may be further configured to receive the product information via manual user input. In some cases, the processing circuitry may be further configured to receive the product information via scanning a label of the product. In some cases, the processing circuitry may be further configured to receive the product information via manual user input and scanning a label of the product. In a further example embodiment, the product information may include at least one of a model, product identification number, store location, price, size, description, brand, color, age, or wear. In an even further example embodiment, the processing circuitry may be further configured to determine an estimated value of the product based on the product information. In an example embodiment, the profile information may include at least one of a name, body measurements, and product preferences. In an example embodiment, the processing circuitry configured to provide the recommended actions may include being configured to suggest that the user dispose of the product. In some cases, the processing circuitry may be further configured to query inventory of participating retailers in response to providing the recommended actions to the user. In a further example embodiment, the processing circuitry configured to provide the recommended actions may include being configured to inform the user that the product is discounted at a local retailer. Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements or functions, it should be appreciated that different combinations of elements or functions may be provided by alternative embodiments without departing from the scope of the appended claims. In this regard, for example, different combinations of elements or functions than those explicitly described above are also contemplated as may be set forth in some of the appended claims. In cases where advantages, benefits or solutions to problems are described herein, it should be appreciated that such advantages, benefits or solutions may be applicable to some example embodiments, but not necessarily all example embodiments. Thus, any advantages, benefits or solutions described herein should not be thought of as being critical, required or essential to all embodiments or to that which is claimed herein. Although specific terms are employed herein, they are used in a generic and descriptive sense only and not for purposes of limitation. In an example embodiment, the information corresponding to the user may include at least one of a name, body measurements, and product preferences. In some cases, the personal inventory manager may further include an inventory module configured to query inventory of participating retailers in response to providing the recommended action to the user.

That which is claimed:

1. A personal inventory manager comprising processing circuitry configured to:
monitor a virtual product library of a user, wherein the virtual product library is generated based on product information corresponding to at least one product and profile information corresponding to information about the user; and
provide recommended actions to the user based on the product information and the profile information in the virtual product library.

2. The personal inventory manager of claim 1, wherein the processing circuitry is further configured to receive the profile information via manual user input.

3. The personal inventory manager of claim 1, wherein the processing circuitry is further configured to receive the product information via manual user input.

4. The personal inventory manager of claim 1, wherein the processing circuitry is further configured to receive the product information via scanning a label of the product.

5. The personal inventory manager of claim 1, wherein the processing circuitry is further configured to receive the product information via manual user input and scanning a label of the product.

6. The personal inventory manager of claim 1, wherein the product information comprises at least one of a model, product identification number, store location, price, size, description, brand, color, age, or wear.

7. The personal inventory manager of claim 6, wherein the processing circuitry is further configured to determine an estimated value of the product based on the product information.

8. The personal inventory manager of claim 1, wherein the profile information comprises at least one of a name, body measurements, and product preferences.

9. The personal inventory manager of claim 1, wherein the processing circuitry configured to provide the recommended actions includes being configured to suggest that the user dispose of the product.

10. The personal inventory manager of claim 9, wherein the processing circuitry is further configured to query inventory of participating retailers in response to providing the recommended actions to the user.

11. The personal inventory manager of claim 1, wherein the processing circuitry configured to provide the recommended actions includes being configured to inform the user that the product is discounted at a local retailer.

12. A method comprising:
monitoring a virtual product library of a user, wherein the virtual product library is generated based on product information corresponding to at least one product and profile information corresponding to information about the user; and
providing recommended actions to the user based on the product information and the profile information in the virtual product library.

13. The method of claim 12, further comprising receiving the product information via scanning a label of the product.

14. The method of claim 12, further comprising receiving the product information via manual user input and scanning a label of the product.

15. The method of claim 12, wherein the product information comprises at least one of a model, product identification number, store location, price, size, description, brand, color, age, or wear.

16. The method of claim 15, further comprising determining an estimated value of the product based on the product information.

17. The method of claim 12, wherein the profile information comprises at least one of a name, body measurements, and product preferences.

18. The method of claim 12, wherein providing the recommended actions to the user includes suggesting that the user dispose of the product.

19. The method of claim 18, further comprising querying inventory of participating retailers in response to providing the recommended actions to the user.

20. The method of claim 12, wherein providing the recommended actions to the user includes informing the user that the product is discounted at a local retailer.
